(19) United States
(12) Patent Application Publication
(10) Pub. No.: US 2025/0196127 A1
(43) Pub. Date: Jun. 19, 2025

(54) APPARATUS FOR INVESTIGATING CHEMICAL PROCESSES IN PLATE-LIKE CELLS

(71) Applicant: HTE GMBH the high throughput experimentation company, Heidelberg (DE)

(72) Inventors: Andreas MUELLER, Heidelberg (DE); Michael DEJMEK, Heidelberg (DE); Oliver PUETTMANN, Heidelberg (DE); Florian HUBER, Heidelberg (DE); Guido WASSERSCHAFF, Heidelberg (DE)

(73) Assignee: HTE GMBH the high throughput experimentation company, Heidelberg (DE)

(21) Appl. No.: 18/851,771

(22) PCT Filed: Mar. 24, 2023
(86) PCT No.: PCT/EP2023/057610

§ 371 Date: Sep. 27, 2024

(30) Foreign Application Priority Data
Mar. 29, 2022 (EP) 22164980.9

(51) Int. Cl. B01L 3/00

(52) U.S. Cl. CPC B01L 3/502; B01L 2200/028; B01L 2300/0645; B01L 2300/0663; B01L 2300/14; B01L 2300/18; B01L 2400/0478; B01L 2400/06

(57) ABSTRACT

The invention relates to an apparatus and a method for investigating chemical processes in plate-like reaction cells which can be fixed flexibly and independently in the apparatus. an investigation of stacks of plate-like reaction cells also being possible. The plate-like reaction cells are positioned with an outer plate surface in a receiving unit and are then pressed against one another by one or more piston tensioners, the pistons of the piston tensioners acting on the outer plate surface of the plate-like reaction cells, more specifically in each case on the plate surface that is opposite the receiving unit, and sealing the reaction cells tightly and detachably by the action of the pressing force. The plate-like reaction cells or stacked plate-like reaction cells each comprise a plurality of plate-like function elements, with each plate-like reaction cell having at least one feed line for a reactant and at least one discharge line for a product, or with each stacked plate-like reaction cell having at least one feed line for a reactant and at least one discharge line for a product.

### FIELD OF THE INVENTION

The present invention relates to an apparatus for studying chemical processes, to a multitude of reaction cells in plate form for studying chemical processes, and to a method of studying chemical processes, with the aid of which it is possible to undertake process-related or material-specific optimizations simultaneously or in a close correlation in time on a large number of functional elements with variation of the process parameters.

### BACKGROUND OF THE INVENTION

In the field of high-throughput research, there is a constant need to be able to conduct the tests and examinations to be conducted more quickly and efficiently. Particularly in the field of development of catalysts and the optimization of processes, it is a very complex matter to bring the components to be tested into the corresponding apparatuses in order then to subject them to corresponding tests. For the study of catalysts, apparatuses and processes, including the software programs required, are provided in order to improve and to accelerate research work. As a result, it is possible to simulate industrial processes with high accuracy in the laboratory. The large amount of data and high accuracy help in reducing the number of studies that are conducted on the pilot plant scale. As a result, it is possible to save time and energy in the development of products.

Even going back several decades, the prior art discloses apparatuses and processes for studying chemical processes in the field of high-throughput research.

WO-A 2009/046944 discloses that tubular reactors can be closed and sealed with a common occlusion system.

EP-A 1 256 377 discloses an array having a multitude of vessels having a closure element in the outer zone. The closure element is pushed against the outer edge of the vessel. A multitude of vessels are simultaneously put under pressure in order to enable a fluid-tight connection.

CN 11318926 discloses a method of high-throughput screening of catalysts for water electrolysis.

WO-A 2021/048375 discloses a stacked plate reactor which is used to study chemical processes, wherein the stacked plate reactor has a multitude of plate-shaped building blocks alongside one another.

WO 2013/074551 discloses capillary flow reactors that are also referred to as porous flow reactors. Capillary flow reactors that are used for performance of chemical and biological multiphase conversions have a plate-shaped structure. The reactors may have one or more chambers and different contact regions in the chambers, for liquids or for gases.

WO 2019/0131634 A1 describes electrolysis cells for electrolysis or co-electrolysis of water or of fuel cells (SOFCs). Some elements of the electrolysis cell are closed by screw connections. Furthermore, the electrolysis cell, in addition to the screw connections, also has a piston and a spring or set of bellows. The piston guides a conduit through the interior that leads into the reaction space of the cell. The piston is movable and enables pressure compensation in the interior if desired on account of the reaction processes.

U.S. Pat. No. 4,756,817 describes an apparatus for pressing and moving flat structural elements in plate form that include first and second carrier elements. Side rails are mounted on the carrier elements. In the apparatus, the structural elements in plate form are in a movable arrangement and are pressed against one another.

It is an object of the invention to provide an apparatus and a method for improving electrochemical processes.

### SUMMARY OF THE INVENTION

The present invention provides an apparatus for studying chemical processes according to the independent claims, with further embodiments of the invention embodied in the dependent claims.

The objects mentioned here, and further objects that are not specified, are achieved by the apparatus described hereinafter: specifically, an apparatus for studying chemical processes in re-action cells in plate form, having:
a group of reaction cells in plate form or a group of stacks comprising reaction cells in plate form or else comprising individual reaction cells in plate form, and a pressing device that enables independent fixing of the individual reaction cells in plate form and stacked reaction cells in plate form,
wherein the closure system comprises receiving units and a multitude of piston clamp units, wherein the piston clamp units have a common drive system,
each reaction cell in plate form or each stack comprising reaction cells in plate form has two outer plate surfaces, where one outer plate surface in each case is in contact with a receiving unit and the other outer plate surface with one or more piston clamps of each piston clamp unit, wherein the piston clamp unit is designed to independently subject the reaction cells in plate form or stacked reaction cells in plate form to a compression force, where the compression force acts at right angles to the plate surface in the direction of the receiving unit,
wherein the reaction cells in plate form or stacked reaction cells in plate form each comprise a multitude of functional elements in plate form, where the functional elements in plate form are catalyst layers, gas diffusion layers, bipolar plates, proton exchange membranes, wherein each reaction cell in plate form has at least one inlet for a reactant and at least one outlet for a product, and wherein the stacked reaction cells in plate form each have at least one inlet for a reactant and at least one outlet for a product.

The invention relates to an apparatus for accommodating and fixing a multitude of reaction cells in plate form by means of a contact-pressure occlusion system. The reaction cells in plate form each have two outer plate surfaces, where one outer surface of the reaction cell in plate form is in contact with a receiving unit and the other outer surface of the reaction cell in plate form is in contact with one or more pistons of a piston clamp element. The movement of the pistons in the direction of the receiving unit exerts a compression force on the reaction cells in plate form which is aligned at right angles to the plate surface. The receiving unit thus forms a stop against which the reaction cells in plate form are pressed. The reaction cells in plate form comprise different functional elements in plate form which also include elements having sealing functions and which are sealed off from the environment in a releasable manner by the compression force. The interiors of the reaction cells may be supplied with fluids, where electrodes may also be disposed in the interiors, to which a voltage may be applied.

In a preferred embodiment, the piston clamp units have a fluidic drive system, wherein the piston clamp units are connected by conduits to a common fluid supply conduit or to a common fluid supply tank, wherein the common fluid supply conduit or fluid supply tank is connected to a pressure regulator valve, preferably an Equilibar valve, and the fluid is also preferably a pneumatic or hydraulic fluid, wherein there are switching valves in the conduits to the common fluid supply conduit or the common fluid supply tank, wherein the fluid stream through the fluid conduit to the piston clamp units can be switched on and off by means of actuation of the switching valves. “Switching on” means opening the fluid conduit, and “switching off” means closing the fluid conduit.

The piston clamps are preferably screw-in piston clamps.

The pressure regulator preferably has short settling times. The settling times are preferably <10 seconds, especially preferably <1 second, further preferably <0.5 second. Simultaneously with the short settling times, the pressure regulator has a large dynamic control range in the range from 1 to 500 barg, preferably 5 to 50 barg, where the pressure regulator is characterized by high sensitivity and is capable of detecting pressure changes <500 mbarg, especially <250 mbarg.

The reaction cells in plate form are actuated individually by the pistons of the pressing device. In a preferred embodiment, the pistons of the piston clamp element are moved by a fluidic drive, and the fluid drive further preferably comprises a hydraulic fluid or is a hydraulic drive. It is preferable that supply conduits of the pistons are equipped with valves. The valve controller allows the connection to the supply conduits of the individual pistons to be selectively stopped, and the reaction cells in plate form to be decoupled from the supply conduits. After the stoppage and decoupling, the selected reaction cells in plate form can be removed from the pressing device. The reaction cells in plate form may be exchanged, or else it is possible to exchange individual elements of the reaction cells in plate form. The fluidic supply conduits are preferably connected to a main conduit provided with a common pressure regulator, which is further preferably an Equilibar pressure regulator. On account of the common pressure regulator, the individual pistons that exert a compression force on the reaction cells in plate form are actuated with the same target pressure via the fluidic supply conduits to the pressure regulator connected.

The onward conduction of the fluidic driving force to the clamps may be implemented in construction terms by means of a manifold in which the conduits are implemented as a sequence of channels that have been drilled or produced by 3D printing, which, together with the valves and screw-in pistons therein, form a body connected to the common supply. The onward conduction can also be implemented as a sequence of pipelines that connect valves and clamps, which are likewise connected to the common supply. Both variants are functionally equivalent; the manifold variant can additionally transmit forces, i.e., for example, form part of a frame which is needed in both variants in order to absorb the fluidically generated force—and the resultant opposing forces.

It should be mentioned here that the forces may also be applied electrically by means of appropriate drives and gears.

In a preferred embodiment, the fluidic supply conduits are supplied from a pressure vessel to which a pressure regulator and a further fluidic supply conduit for a readily compressible fluid are connected. The readily compressible fluid is, for example, a gas. The advantage of this arrangement is that the pressure can be regulated very accurately via the readily compressible fluid, while the compression force is exerted via a comparatively noncompressible fluid, for example a liquid. The latter has the further advantage that, in the volume in the fluid conduits that has been filled with the comparatively noncompressible fluid and shut off by the switching valves, it is possible to detect even very small changes in the expansion or yielding of the reaction cell. This means that a pressure measurement in this enclosed volume is also suitable as a method of detection for minor instances of expansion or yielding, for example in the seal that concludes the reaction space.

Further preferably, the compression force of the pistons may also be exerted on a stack of reaction cells in plate form, such that it is possible to accommodate a multitude of stacks of reaction cells in plate form in the apparatus. In a further-preferred embodiment, accommodation of multiple individual reaction cells in plate form may be combined with accommodation of stacks of reaction cells in plate form. One advantage is the flexibility of the apparatus in the arrangement of reaction cells in plate form. When reaction cells in plate form with defined dimensions are used, adjustment of the construction of the apparatus is possible in a very simple manner, such that it is easily possible for the operator of the apparatus to use the apparatus of the invention for a multitude of different processes. Thus, the apparatus of the invention is a multifunctional apparatus which, because of the flexibility with which it can be used, is of great industrial interest.

The reaction cells in plate form comprise exchangeable functional elements in the form of layers or plates. As a result, those elements having signs of wear can be exchanged in a particularly simple manner. The term “wear” may also mean corrosion brought about in a controlled manner, in which case the method is used to simulate, in the laboratory, the conditions to which materials are exposed in real operation. This includes surface damage to electrodes, but also damage to pipe or vessel materials, seals or membranes. In addition, the elements of a reaction cell may be combined in different configurations, which allows very many different processes to be conducted. This also shows the high performance capacity of the apparatus of the invention. The reaction cells in plate form may be operated in parallel or in series. It is thus possible to conduct multistage processes in series-connected reaction cells or to conduct analysis for up-scaling of processes in parallel-connected reaction cells. The apparatus thus has very high versatility in a very high-performance manner since rebuilding and extension operations, on the basis of the individual seals of the reaction cells in plate form, are very easy to manage. It is thus possible to use the apparatus of the invention very efficiently for screenings and optimization of process conditions, which surpasses existing apparatuses in terms of performance properties as well owing to usability and flexibility. The apparatus of the invention has great technical benefit since it constitutes the basis for 1. optimization of chemical processes based on the use of electrical power for synthesis of chemical compounds and 2. optimization of chemical processes in which chemical compounds and molecules as fuel are converted to electrical power. The corrosion that is manifested here on the electrodes or in the inner walls of the reaction cells or on the functional elements is part of the electrochemical processes that are the subject of specific analysis and optimization. The improvement of industrial scale processes using renewable energy sources in combination with new process technology can and will contribute to further reduction of the CO₂ emissions of the chemical industry. The apparatus of the invention is a high-performance tool for optimization of chemical processes. The optimization is time-saving by virtue of modular structural elements in combination with a pressing device, which enables individual sealing and individual exchange of individual reaction cells in plate form and which is easy to operate.

In a preferred embodiment, the piston clamp unit of the occlusion system is characterized in that it has one piston clamp per reaction cell in plate form or one piston clamp per stack of reaction cells in plate form. The dimensioning and clamping performance of the piston clamp used are matched to the dimensioning of the reaction cell in plate form such that the apparatus of the invention has only a small number of piston clamps, which reduces complexity and improves the ease of use of the apparatus. Reduced complexity and improved ease of use is important since the apparatus of the invention can be used to accommodate a large number of reaction cells in plate form. The number of reaction cells in plate form that can be disposed in the apparatus simultaneously or in parallel and can be pressed independently by piston clamps is in the range from 2 to 50, more preferably in the range from 2 to 40, even more preferably in the range from 4 to 20.

There is preferably a force distributor element at the tip of each piston of the piston clamps; the force distributor element preferably has a ball bearing that has at least one ball and compensates for slight variances in the parallelism of the piston end face and the outer face of the reaction cells. The force distributor element offers the advantage that the compression force is transmitted uniformly to the sealing element(s) that seal(s) the interior of the reaction cells in plate form from the outside.

In a preferred embodiment, the reaction cells in plate form are reaction cells in plate form for performance of electrochemical methods selected from the group of: electrolysis cell, galvanic cell, fuel cell, corrosion test, flow batteries, redox flow batteries, e.g. vanadium redox batteries. Further preferably, a reaction cell in plate form comprises at least two half-cells separated by a feeds dividing and wall. product Depending drains. on the embodiment, a reaction cell may also have multiple reactant

A reaction cell in plate form configured as an electrolysis cell or galvanic cells has a separation membrane and electrodes, where the reaction cell is divided into half-cells by the separation membrane, where the electrodes are connected to electrical supply wires. Especially preferably, the reaction cells in plate form are configured as electrolysis cells, where it is preferable that the electrodes are connected to current and voltage measurement devices; the apparatus further preferably comprises online analysis devices from the group of online voltammetry for measurement of V/A functions, impedance spectroscopy for measurement of high-frequency voltage changes. By means of the apparatus of the invention, it is possible to conduct very exact measurements, where the apparatus is characterized by flexibility and accuracy. A combination of the electrochemical analysis methods with sensor monitoring of the seal system of the reaction cells in plate form offers synergies here which result from the fact that the sensor monitoring is capable of recognizing changes in the reaction cells in plate form that can be correlated with the electrochemical data. In this way, it is possible to identify disruptive effects that lead to changes in electrochemical measurement data.

In a preferred embodiment, each reaction cell in plate form has at least one inlet and at least one outlet via which supply media are supplied and product media are led off. The reaction cell in plate form may have a dividing wall in the middle, where the dividing wall divides the cell into half-cells, where each half-cell may have at least one inlet and at least one outlet.

In a further embodiment, only one of the two half-cells may have an inlet, where each half-cell has at least one outlet. One of the half-cells may also have two outlets, where one outlet is intended for the draining of liquid fluids and the other outlet for the draining of gaseous fluids. The outlet may also have a condenser together with a recycling conduit, where the liquid fluids are separated from the gaseous fluids in the condenser and guided to the inlet via the recycling conduit. Recycled fluid can then be directed into the interior of the reaction cell together with fresh fluid.

The main body of the reaction cells in plate form is housing plates that surround the functional elements. The housing plates comprise the connections to the inlets and outlets for fluids, and also the connections to the electrical connection wires. The connections to the inlets and outlets or else the electrical connections may be run through the base surfaces or through the lateral surfaces of the housing plates. The structural arrangement of the connections depends on the 10 dimensions of the reaction cells in plate form and the structural environment in which the reaction cells in plate form are arranged. There may be heating elements in the environment of the reaction cells in plate form in order to operate the reaction cells in plate form at high temperatures. It is possible to provide cooling elements in order to accelerate the processes of cooling of the reaction cells in plate form. The reaction cells in plate form may be equipped with temperature measurement sensors.

It is preferable that the connections to the inlets and outlets for fluids are provided with connection elements that are easy to use, in order to be able to exchange individual reaction cells in equipped with fast coupling elements. For example, particularly suitable fast coupling elements plate form within short periods of time. It is thus particularly preferable that the connections are are those supplied by Stäubli.

In a preferred embodiment, the piston or force distributor element is equipped with a sensor that can measure a geometric change in the reaction cell during the reaction; sensors are (indirect) force measurement sensors or (direct) measurement sensors such as expansion measurement strips, distance detectors such as ultrasound barriers and optical light barriers, or interference methods. Sensor measurement offers the advantage that wear of the sealing elements can be monitored and controlled. Direct measurement as a geometric change in the reaction cell has the advantage over the described indirect measurement via hydraulic pressure that the measurement can be conducted continuously, whereas the measurement of hydraulic pressure is always combined with the adjustment of the switching valves.

In the case of parameters that affect long-term performance capacity, a distinction should be made between physical and processing parameters. The physical parameters are mechanical and chemical stability of the functional elements. These include the surface wettability of the gas diffusion layer, the pressure characteristics of the gas diffusion layer, the ion conductivity of the membrane, and stability of the sealing elements. The processing parameters are the process conditions chosen for the performance of the method. These include the process pressure, the process temperature and the ranges of variation that are employed in the operation of the reaction cell with the processing parameters, and the reaction times with which the operating conditions are altered. In a preferred embodiment of the method, the reaction cells arranged in parallel are subjected to a compression force which is imparted by a common pressure regulator. It is necessary here for the compression force applied for sealing of the individual reaction cell in plate form to be greater than the pressure in the interior of the individual reaction cells. Another aspect is that the individual reaction cells in plate form can be used simultaneously under different operating conditions. In this way, the individual functional elements may have different wear characteristics. In a preferred embodiment, the reaction cells in plate form are equipped with force sensors that record compression force as a function of time. The equipping of the reaction cells in plate form with force sensors is advantageous since it is possible to monitor the operation of the individual reaction cells and to register the control data, and also to implement the process examined in conjunction with feedback coupling.

In the modes of operation of the processes, it is possible to distinguish between breaking-in and aging processes. These modes of operation may be passed over as defined processes to an automated test plant in the form of protocols with a defined execution list. This execution list then defines the procedural and electrical requirements on the test plant as a series in time. Breaking-in protocols can be defined such that a desired performance of the reaction cell is obtained after execution of the list. The process monitoring protocol can be defined such that customary or even rare states of operation of a reaction cell are established and, for example, the power thereof in these states of operation is monitored. The states of operation present may be changing states of load-such as startup or rundown of a reaction cell. The study of the long-term characteristics of a reaction cell can be undertaken under more severe operating conditions, for which the protocol used may have elevated operating temperatures or high frequencies of load changes.

In a preferred embodiment, one or more of the reaction cells in plate form have one or more sensors connected to sites in the interior of the reaction cells, wherein the sensors are sensors for the performance of in situ test methods selected from the group of electrochemical dilatometry for characterization of the change in thickness of electrodes, light-microscopy characterization or spectroscopy characterization by means of glass fibers relating to electrodes or membranes. The monitoring of the interior of the reaction cells in plate form during the process is advantageous in order to assure improved process optimization. This results in synergistic effects since the improved monitoring is also combined with improved test utilization time resulting from the individual closability and resulting exchangeability. These synergistic effects are also important in the case of high-throughput research since different process conditions can be tested simultaneously. The reaction cells in plate form that are subjected to particularly demanding process conditions—for example in relation to temperature or else in relation to the composition of functional elements—can therefore be exchanged individually.

In a preferred embodiment of the apparatus, the receiving units take the form of physically separate units or of a physically connected unit. If the receiving units take the form of physically separate units, each receiving unit has a dedicated holding frame connected to one piston clamp unit. If the receiving units take the form of a physically connected unit, the receiving units have a common holding frame, wherein the piston clamp units are preferably arranged in a common element, wherein the common holding frame connects the receiving units and the common element. The common holding frame may be advantageous in order to assure stabilization of the apparatus. The separate holding frames may be advantageous in order to position the units at distributed sites. It is also conceivable to combine groups of reaction cells in plate form in one apparatus, in which case the apparatus has two separate units, for example, and has one group with a common holding frame.

In a preferred embodiment of the apparatus, the reaction cells in plate form have an inner wetted plate area in the range from 1.5×1.5 cm² to 30×30 cm², the inner plate area is preferably 2.0×2.0 cm² to 25×25 cm², and the inner plate area is further preferably 3.0×3.0 cm² to 15×15 cm². It can be stated that the dimensions of the reaction cells in plate form may also be very small. At the same time, the arrangement is characterized by high accuracy since the functional elements can be monitored by sensors, such that a variety of measurement data is captured. The dimensions of the outer larger plate surface are such that fluidic and electrical connections can be attached.

In the operation of the individual reaction cells under high load, the functional elements are subjected to higher forces than in the case of low load. In a selected configuration of reaction cells, use of a defined compression or compression force is important in order to rule out uncontrolled deformation of the diffusion layer, which can lead to a change in the process parameters and the resulting measurement data. Conversely, the behavior of a diffusion layer under different levels of compression can be examined by specifying a defined load. In this case, it should be ensured by means of suitable cell geometry that the sealing force (which is constant in this case) and the (adjustable) compression force of the diffusion layer are decoupled. Forces that act at right angles to one another may be independent of one another. Therefore, a cylindrical reaction cell wherein the sealing is effected on the inside of the cylinder wall, similarly to a piston seal, equipped with a strain gauge on the piston end face which is then at right angles to the inside of the cylinder, has strain characteristics that are independent of the sealing force. Another possibility is to measure the strain characteristics of an internal membrane with a likewise internal sensor. A disadvantage of this method is the cable bushing to the outside. A third possibility is to establish a negligible internal pressure via appropriately dimensioned to distributor and outlets in the reaction cell. In that case, the negligible internal pressure does not cause any changes in stress to the outside strain gauge of the reaction cell, which is axially flush with the clamp device. Strains that are measured here can only be caused by, for example, swelling characteristics of the internal membrane.

Operation in the case of exertion of a constant compression force may be important for the quality of the measurement. It is also advantageous that the weakening of the sealing effect can be monitored. By means of the apparatus of the invention, it is possible to record and examine the influence of the conditioning and fractures in the protocol.

In one example, a reaction cell in plate form may be designed as an electrolysis cell. The apparatus in which multiple reaction cells in plate form are disposed is then used as electrolysis cell for examination of the breakdown of water. It is possible here for the separate reaction cells in plate form to be present in a series arrangement or in a parallel arrangement. A reaction cell in plate form which is designed as an electrolysis cell comprises at least two half-cells separated by a membrane (proton exchange membrane or electrolyte).

In one configuration form, a reaction cell in plate form as electrolysis cell may have the following functional elements: dividing wall, catalyst layers, diffusion layers, electrode layers, sealing elements. In addition, the reaction cell in plate form has fluid spaces through which the fluid to be broken down, water in the present case, is guided. The reaction cell in plate form comprises at least two housing plates. The fluid spaces may be recessed into the housing plates. In a preferred execution, the fluid spaces have a structure in the form of channels. The structure in the form of channels improves the dwell time characteristics of the fluid by directing each fluid element by guiding very specifically in one path, it being preferable that the distance has very substantially the same length for all paths. Narrow dwell time characteristics of a reaction mixture are advantageous since they can improve the reaction yield and reduce the proportion of further reactions. The structure in the form of channels may have one or more than one channel. The dividing wall is disposed between the two housing plates, where sealing elements that seal at least the space from the exterior are disposed in the edge regions.

With regard to the term “fluid space” or “supply space”, it can be stated that the interiors of the reaction cells in plate form may have different structures, and they may therefore be supply spaces or function spaces.

The dividing wall is framed on either side by layers of the functional elements, where the dividing wall is in contact on each side of the wall surface with the catalyst layer, the diffusion layer, the transport or supply space and the electrode layers. The sequence of functional elements may be constructed somewhat differently from reaction cell to reaction cell. For example, it is possible that functional elements are combined in one layer or merge into one another. For example, the catalyst may be disposed in the diffusion layer. The electrode layers may be configured in mesh form. In addition, the electrode layers may also be disposed in the inner surface of the housing plates.

In the case of the apparatus with reaction cells in plate form for breakdown of water, at least one half-cell of the reaction cell in plate form is equipped with a feed for supply of water. The protons pass through the dividing wall and are reduced to hydrogen on the cathode side. On the anode side, the water reacts to give oxygen and protons. On the anode side, water is directed through the fluid space, and a mixture of water and oxygen is directed along the fluid channel. On the cathode side, hydrogen is directed through the fluid space.

In the example, the reaction cells in plate form are reaction cells for electrolysis of water or electrolysis cells. The half-cells on the anode side are moistened by the water. The functional elements in plate form are catalyst layers, gas diffusion layers, bipolar plates, proton exchange membranes. Plate reactor comprises at least two housing plates comprising functional layers in plate form, also including sealing elements. The term “bipolar plates” refers to technical functional elements that bring about spatial separation of reaction cells and electrical supply of the electrodes, and that simultaneously enable distribution of the reactants or products uniformly in the area.

The reaction cells in plate form preferably each comprise a multitude of functional elements in plate form, selected from the group of catalyst layers, gas diffusion layers, bipolar plates, proton exchange membranes, anion exchange membranes, separation membranes. What is meant by a multitude is that there are at least two or more functional elements. The number of functional elements is guided by the type and configuration of the reaction cell in plate form. There are also possible embodiments in which there are two or more functional elements in one combined element. This means that functional elements within a reaction cell are already preconfigured by virtue of a fixed connection.

In addition, there are also possible embodiments in which different types of reaction cells in plate form are arranged in a modular form. The different types of reaction cells in plate form may be electrolysis cells, membrane cells, catalysis membrane cells, redox cells. These different types of reaction cells in plate form may be present in the different receiving units, for example as apparent from the schematic diagram of the apparatus shown in FIG. 8a. In addition, there is also a possible embodiment in which reaction cells in plate form are present in the same receiving unit and form a quadruple cell configuration. These may be arranged in the apparatus shown in FIG. 11, on the left-hand side.

The terms “functional elements” and “functional layers” are used synonymously. It should be noted that not all sealing elements must have a layered structure, but it is also possible to use sealing rings or angular sealing elements.

In one of the embodiments, individual functional elements are integrated into the housing plates. In one of these embodiments, the gas diffusion layers are fixedly connected to the housing element. This embodiment exists when the functional elements are used in a defined design which is unchanged and does not have any significant wear, such that there is no need to exchange this functional element. The sealing elements that are exchangeable or reusable may be functional elements.

Since the reaction cells in plate form are releasably connected to one another, it will be clear that the connections have been provided with sealing elements. The selection and characteristics of the sealing elements are guided by the respective process parameters or process conditions under which the reaction cell is used.

Embodiment of the plate reactor as fuel cell with proton exchange membrane.

In one configuration form of the apparatus in which the individual reaction cells in plate form are each in contact with a force sensor, it is possible to monitor the contact pressing force of the reaction cells and to conduct the study in a dynamic mode of operation of the cell. The reaction cells may be equipped with an optical connection or access to the interior. The equipping of the cell space with means of analysis has the advantage that the cell interior is made accessible to in situ analyses selected from the group of UV, IR, NIR, MIR, laser diffraction, optical imaging methods. For this purpose, the housing surfaces of the reaction cells in plate form may have window regions which are transparent to radiation and which also have detection surfaces in order to absorb the reflected radiation signals.

In one configuration form, the pistons of the piston clamps have been provided with cylindrical bars by which the distances between the reaction cells in plate form and the drive of the piston clamps can be increased. This has the advantage that the reaction cells in plate form can also be operated at high temperatures since the fluidic drive of the piston clamps has thermal decoupling, or the correct spatial circumstances exist. Thermal decoupling can be improved in that a heat shield disposed below the drive of the piston clamps provides shielding from the radiative heat. The heat shield is manufactured from a material that barely conducts the heat, if at all. For example, a ceramic plate. Apart from that, the drive of the piston clamps may be equipped with a cooling device in order to prevent transfer of the heat from the heating device for the reaction cells to the drive of the piston clamps.

In a preferred embodiment of the apparatus of the invention, the pistons of the piston clamps are equipped with spacer elements, and in a preferred embodiment the spacer elements comprise a heat shield or a cooling device or a heat shield and a cooling device. The combination of spacer elements in conjunction with heat shield and a cooling device is advantageous in order to operate the reaction cells in plate form at high temperatures.

The individual reaction cells in plate form have been provided with an identifier, specifically in the form of a barcode, number code or other identifier. The program controller in the system detects which cell is being used in which position.

Preference is further given to an embodiment of the apparatus in which the receiving units have carrier elements in the form of grooves, depressions or compartments in which the reaction cell in plate form or stacked reaction cells in plate form are positioned, the carrier elements preferably having spacer elements equipped with means of thermal decoupling. The carrier elements enable high positioning accuracy of the reaction cells in plate form.

In a preferred embodiment, the group of reaction cells in plate form or a group of stacks comprising reaction cells in plate form or a group of reaction cells in plate form comprising one or more stacks of reaction cells in plate form is surrounded by a temperature control device, wherein the device preferably has a heat chamber in which two or more components of the apparatus are disposed, and the different components further preferably each have separate temperature control devices.

It should be noted that the configuration form of the apparatus in which the piston clamps are provided with cylindrical bars is particularly preferable when, in the apparatus for examination of processes, the reaction cells in plate form are ceramic reaction cells. These may be high-temperature electrolysis or high-temperature fuel cells, which are also referred to as solid-state electrolysis cells or solid oxide electrolyte cells (abbreviated to SOECs) or as solid-state fuel cells or solid oxide fuel cells (abbreviated to SOFCs).

In one configuration form, the reaction cells in plate form may be designed as fuel cells. In a further configuration form, the fuel cells may have individual stacks.

The apparatus of the invention may be used to monitor the behavior of the sealing elements under the action of the compression force as a function of time. It is thus possible to very specifically examine aging processes. The study may relate to the study of the aging processes that occur at the sealing elements or at the functional elements. The study of the effect of the compression force is preferably started as soon as the reaction cells have reached constant operating conditions in order that the temperature-related change in length of the reaction cells is not wrongly interpreted as expansion or yielding of flexible components (seals, membranes). Therefore, the reaction cells and the pressing apparatus are also present in a temperature-controlled chamber or in an oven chamber.

In one embodiment, the apparatus may be used to conduct the processes that are conducted in the reaction cells in plate form in a periodic mode of operation, where individual measurement cycles may also be repeated.

Assembly structures and classification into functional elements: results from housing plates, fluid distributor plates, electrodes and central membrane assembly with exchangeable or reusable sealing elements. The reaction cells may have a staged configuration. In this staged configuration, the membrane assembly is at the center of the reaction cells between the two housing plates, where the membrane assembly may be covered by catalyst layers on one side of the membrane or else on both sides of the membrane. The catalyst-coated membrane assembly is a catalytic membrane assembly. The membrane assembly covered with catalyst layers may be covered on either side with layers of diffusion elements, preferably gas diffusion elements. Diffusion elements are characterized in that they have a polarity and a porosity that improve the process since they give some degree of priority to the passage of desired components and promote the discharge of reaction products.

In one configuration form, the membranes of the reaction cells may be configured as membrane assemblies (abbreviated to MA in the context of the present document) or as membrane electrode assemblies (abbreviated to MEA in the context of the present document).

The use of membrane electrode assemblies or membrane assemblies may be appropriate when components can be manufactured inexpensively as assemblies or when the chemical processes can be conducted particularly efficiently.

Membrane assemblies are advantageous in terms of use since they contribute to a frequently desired separation of function into components with active and inactive character that can be manufactured by different methods. Inactive components are, for example, flow-conducting components or seals. Active components are those that actively participate in chemical conversion or combining of substances or separation of substances. Components involved in the chemical conversion are catalytically coated components. Components that make changes in physical composition are membranes, for example. These are frequently functionalized, where functionalization may relate to the surfaces of the membranes, as a result of which it is possible to regulate wetting characteristics, for example. The inactive components may be produced by methods of production technology such as structuring, cutting, punching, film extrusion, film casting, etc. Active components may additionally be treated with chemically active components. These include spray coating, knife coating, sputter coating, CVD coating, sol-gel coating, impregnation. The finished cell is then assembled from active and inactive components to give a membrane assembly.

With regard to the structural makeup of membrane assemblies, it can be stated that the membrane constitutes a central component that functions primarily as an ion-conducting layer and, in a preferred embodiment, also comprises a catalyst or a catalytic layer on at least one or both sides.

Reaction cells in plate form with housings and sealing elements, connections, inlets and outlets for gases and liquids, electrical terminals.

The invention is illustrated by description of structural configuration forms of reaction cells in plate form that may be used in conjunction with the apparatus for studying chemical processes. It is possible to produce various reaction cells in plate form that result from different configurations of membrane assemblies.

In one configuration form, the reaction cell in plate form may be configured as a solid oxide fuel cell (SOFC) having an ion exchange membrane as the central separating element. The ion exchange membrane is covered with a porous catalytic layer on both sides of the separation layer, where the porous catalytic layers may be covered by diffusion layers.

In a further configuration form, the catalytic layer of fuel cells comprises a carbon-containing or graphite-containing material, or a material containing carbon and graphite, on the surface of which may be deposited active components or active elements. The carbon-containing material or the graphite-containing material has agglomerates, the size of which is in the range from 40 to 100 nm. The agglomerates may comprise carbon-containing or graphite-containing primary particles having a size in the range from 10 to 30 nm. The active components or active elements are present on the surface of the primary particles and have a size that may be in the range from 2 to 5 nm. The individual agglomerates may be encased by a polymer membrane. In a preferred embodiment for low temperatures (<200° C., <473.15 K), the polymer membrane is a Nafion membrane. Nafion is a trade name for a polymer material from DuPont, which is a sulfonated tetrafluoroethylene polymer (PTFE). The electrodes present may be a wire mesh, where the wire mesh may be disposed in the region between the porous catalytic layer and the diffusion layer or within the catalytic layer or between the catalytic layer and the proton exchange membrane. The layer thickness of the proton exchange membrane is preferably in the range from 0.5 mm to 10 mm, further preferably in the range from 1 mm to 8 mm. The thickness of the porous catalytic layer is preferably in the range from 50 μm to 1000 μm, further preferably in the range from 100 μm to 250 μm. The diffusion layer preferably has a layer thickness in the range from 50 μm to 250 μm. The fluid space through which the fuel or working fluids are transported runs along the surface of the diffusion layer.

One aspect of the apparatus of the invention relates to the option of upscaling the experimental arrangement, which can be brought about in that the surface area can be increased in a very simple manner in the case of membranes. The reaction cells in plate form may exist in different dimensions, and these may each be used in the same apparatus with the pressing device. It is thus possible to exchange the reaction cells in plate form that have a smaller dimension for larger reaction cells in plate form. In addition, the individual reaction cells in plate form may also be arranged in stacks of reaction cells in plate form, where the reaction cells in plate form may be connected in a series arrangement, such that the membrane areas of the individual cells can be added up to form a total membrane area. It is thus possible to collect data for upscaling without the need to use a different apparatus, which means that utilization of the apparatus of the invention development in the case of upscaling is very efficient and resource-conserving.

In one configuration form, the reaction cell in plate form may be used as a solid-state electrolysis cell (as what is called an SOEC).

The apparatus of the invention for studying reaction cells in plate form may be part of a modular platform comprising the following modules:
central cabinet with supply device;
supply device for gas and liquids;.
reaction module with apparatus for accommodating and for fixing a multitude of reaction cells in plate form;
online analysis devices or an online analysis unit; and a control device.

The invention also relates to a method of studying reaction cells in plate form by means of the apparatus of the invention.

A method of studying chemical processes in reaction cells in plate form by means of an apparatus which is the subject of the present description, wherein the method comprises the following steps:
a plurality of reaction cells in plate form is positioned with the outer face of the plate on the top side of receiving units, preferably in such a way that the reaction cells have a horizontal orientation and linear arrangement on the top side of the receiving units and are supported owing to gravity;
compressing the reaction cells in plate form by means of piston clamps, where one or more piston clamps per reaction cell in plate form exert a compression force on the outer plate surface of the individual reaction cells that acts at right angles to the plate surface in the direction of the stop and hence closes off the interior of the individual reaction cells in a sealing manner;
establishing the connections of the fluid conduits to the supply conduits and outlets, optionally establishing the connections to the electrical supply wires for the electrodes;
operating the reaction cells in plate form under the chemical process conditions.

Preferably, in the performance of the method, during the operation of the reaction cells under the chemical process conditions, one or more process parameters per reaction cell are registered, and at least one of these process parameters is preferably the compression force with which the individual reaction cells are pressed together.

In the performance of the method, it is further preferable that a comparison of registered process parameters per reaction cell with target parameters is conducted; the target parameters may be given by reference data or by process parameters that are registered in adjacent reaction cells;
exchange of individual reaction cells in plate form by selective release of piston clamps and supply conduits, preferably with continuation of operation of those reaction cells in plate form that are not exchanged.

In addition, in the performance of the method, it is preferable that the method is conducted in combination with an online analysis of the product fluid streams, the method is further preferably conducted in combination with an inline analysis of interiors of one or more reaction cells in operation, and the method is especially preferably conducted in combination with an online analysis of the product fluid streams and an inline analysis of interiors of the reaction cells.

Constituents of the method may also be the performance of conditioning of the reaction cells under selected process conditions. In addition, a constituent of the method may be the performance of analytical characterization studies. The analytical characterization studies may be conducted by online analysis units on the process fluid that emerges from the reaction cells in plate form. The analytical characterization studies may also be implemented in the interior of the reaction cells in plate form, provided that the housing plates are equipped with transparent windows and the corresponding elements for excitation of radiation and detection are present. Apart from that, those functional elements in the interior of the reaction cell that may be subject to wear may be sent to a downstream analytical characterization after removal from the reaction cell. For example, it may be of interest to send the catalyst layer to a downstream characterization. Downstream analysis may relate to detection of the catalyst morphology. A “post mortem” analysis of the catalyst used after the method has been performed. The post mortem analysis can be conducted using any methods of surface analysis known to the person skilled in the art. The methods of analysis of the surface also include: light microscopy, scanning electron microscopy, transmission electron microscopy, EDX, XPS, ICP-OEX, GD-OES, IR, FTIR, SIMS, NMR, XRD, chromatography. In addition, it is also possible to characterize the surface of the catalyst used by laser scanning microscopy, and it is also possible to use a 3D method with depth resolution in the scans. The resolution which is achieved by laser scanning microscopy is 2-3 μm.

It is possible here that the method of laser scanning microscopy is combined with the elements from the group that follows. Laser scanning microscopy can be combined with a camera. This is also true of all other methods of surface analysis. It is thus possible by detection of surface structures (pattern recognition) via the camera in combination with an appropriate algorithm to find the identical spatial sites or points again, which are used to undertake a desired analysis. This procedure allows the collection of different information at fixed coordinates. This method can also be conducted with a very exact coordinate system. However, the problem that exists in that case is to exactly fix the reference point on the sample such that refindability is possible even when the sample is transferred to a different analytical device or instrument.

It is possible to use the following devices in the method: a CCD camera, a confocal laser scanner (<1 μm), laser focus variation, 3D interferometer (<1 nm).

The method of the invention for studying chemical processes in reaction cells in plate form may be characterized in that the reaction cells in plate form can be operated within a temperature range from 298.15 K to 1273.15 K (25° C. to 1000° C.).

In the performance of the method, it is possible to make temperature changes over periods of time, where the temperature steps are in the range of up to 60 K/second. The structure of the reaction cells in plate form offers the advantage that the reaction cells have a large outer area relative to a small volume in the interior. It is therefore possible to implement temperature control very quickly and with high accuracy.

In the performance of the method, it is possible to make a change in the fluid composition or a change in the gas composition with a speed in the region of seconds, or with a frequency in the region of 1 hertz.

The invention also relates to a program controller for control of an apparatus as detailed in the description and the claims, which is used for performance of a method of studying chemical processes, wherein the program controller comprises a database in which the measurements are stored. Further preferably, the performance of the method may be undertaken with a program controller, where the program controller may comprise a selection of programs. The programs may already be present as a library in the program controller. Aside from that, however, the user is also able to create their own programs.

The method can be performed with involvement of online detection methods by means of which the composition of fluid streams is characterized. Methods of online detection used may be rapid analysis methods (repetition rate in the region of seconds, where the measurement time is in the region of ≤30 seconds per measurement, preferably ≤10 seconds per measurement) such as FTIR or else HFID—or else, in the case of steady-state studies (repetition rate in the region of minutes, where the measurement time is in the region of ≥0.5 minute per measurement, preferably ≥1 minute per measurement), gas chromatography.

In the performance of the method, it is possible to simulate different modes of operation which, for example, model the mode of operation of motor vehicles. For example, the conditions of the New European Driving Cycle (NEDC) for motor vehicles with internal combustion engines can be used as a basis. What are then examined are not the pollutants, but rather the efficiency of energy utilization.

Other examples are guided by the conditioning of the reaction cells for achievement of a maximum power output. There are different descriptions of modes of operation here from manufacturers of fuel cell stacks. The following methods or states of operation may also be used here: Constant Current Hold, Voltage Cycling, Air Braking, Hydrogen Pump, Cathode oxidant Starvation, Thermal Cycles with Current Cycling, Combined Temperature and Humidity Cycling. Further details of protocols in the form of literature examples can be found, for example, in the following publication: Current Opinion in Electrochemistry 2022, 31:100843; sciencedirect.com; (https://doi.org/10.1016/j.coelec.2021.100843).

For performance of the method, it is possible to model individual cycles in which the duration of the overall cycle is in the range from 20 seconds to 2000 seconds, where the temperature fluctuations that occur in the performance of the method may be within a range from 273.15 K to 673.15 K (0 to 400° C.).

For performance of the method, the supply module may be used for supply of gases and liquids that may be provided electively or collectively.

In the performance of the method for accelerated conditioning, it is possible to use cyclic voltammetry, which is used either for activation of electrodes or catalysts in the form of conditioning or in order to further improve performance properties by cyclic voltammetry during the performance of the method. By cyclic voltammetry, it is then also possible to study the charge density before and after conditioning under real operating conditions and to correlate the charge density data with performance properties. Using the data, it is then possible to specifically identify those structure-activity relationships that lead to an improvement or deterioration in performance properties.

In the performance of the method, the measurement parameters are at least partly detected and registered automatically by the program controller. Protocols for the performance properties.

Preference is given to using a piston clamp from Enerpac Tool Group. Piston clamps of this preferred type are described in WO-A 202162224. The compressive force applied by means of piston clamps is in the range from 10 to 1000 kN per reaction cell in plate form, especially in the range from 20 to 500 kN per reaction cell in plate form. In the case of polymeric sealing materials, it is preferable that the specific compression force that acts on the surfaces of the reaction cells in plate form is greater than 1 kN per cm², the compression force acting on the contact surface further preferably being greater than 2 kN per cm².

The compression force depends on the sealing element material chosen in the particular case. In the case of metallic sealing materials, the compression force is also in the region of 10 kN per cm² or greater.

The chemical processes that are conducted in the reaction cells in plate form are conducted at temperatures in the range from 273.15 to 1273.15 K, especially within a range from 298.15 to 1073.15 K, more particularly at a temperature in the range from 373.15 to 873.15 K.

In the performance of the method, the pressures are in the range from 0.05 to 500 bara, especially in the range from 0.1 to 300 bara, more especially in the range from 1 to 250 bara.

A reaction cell in plate form is a reaction cell in the form of an individual reaction cell or in the form of stacked reaction cells in plate form, where the individual or stacked reaction cells may be disposed in a position of the receiving unit. If the reaction cells in plate form are in stacked arrangements, an individual stack comprises 2 to 10 reaction cells in plate form; in particular, an individual stack comprises 2 to 6 reaction cells in plate form, more particularly 2 to 4 reaction cells in plate form.

The reaction cells in plate form are used in an execution selected from the group of membrane reactor, electrochemical reactor in the form of fuel cell reactor, electrochemical reactor in the form of an electrolyzer, photocatalytic reactor, especially preferably as a photocatalytic reactor with integrated LED source.

The thickness of an individual reaction cell in plate form is within a range from 0.5 to 5 cm, especially from 0.8 to 4 cm, more particularly in the range from 1.5 to 2.5 cm.

The reaction cells in plate form or individual functional elements of the reaction cells in plate form may have identifiers in the form, for example, of a tag, barcode or RFID chip. This can ensure that the reaction cells in plate form are present at fixed receiving positions of the stop. In this way, it is also possible to monitor controlled assembly of the reaction cells in plate form. In a preferred embodiment, the assembly is at least partly effected by a robot.

The sealing elements that are used for sealing of the reaction cells in plate form are selected with reference to the process parameters under which the reaction cells in plate form are operated. In the case of temperatures exceeding 573.15 K, preference is given to seals comprising a material from the group of metal, graphite. In the case of temperatures up to 573.15 K, seals comprising a material from the group of Teflon, Kalrez, Viton, rubber are used.

If multistage processes are performed, it is preferable that these multistage processes are performed in stacked reaction cells in plate form, such that the process stages are conducted in the different stages of a layer. This arrangement has the advantage that the adjacent reaction cells in plate form that are not disposed in the same receiving position are not coupled to one another. In this way, it is possible to exchange individual reaction cells in plate form in continuous operation, while other reaction cells in plate form are operated further.

Preferred embodiment the apparatus of the invention forms a central module of a multifunctional apparatus which is formed from multiple modules and has great flexibility with regard to the performance of very different chemical processes, and with regard to the addition and exchange of individual functional modules. The invention thus also relates to a multifunctional apparatus comprising the following modules: one or more supply modules, a central reaction module of an apparatus of the invention for accommodation of reaction cells in plate form, an analysis module, a control module with process monitoring and data collection unit.

These and other features are elucidated by the description of figures that follows.

### BRIEF DESCRIPTION OF THE FIGURES

FIG. 1.a shows the schematic setup of a reaction cell in plate form in cross section, designed as an electrolysis plate reactor or as an electrolysis cell in plate form, comprising two half-cells separated by a membrane;

FIG. 1.b shows the schematic setup of a reaction cell in plate form as a top view of the inner face of a housing plate in which a channel structure is provided for conduction of fluid;

FIG. 1.c shows the schematic setup of a reaction cell in plate form as a top view of the inner face of a housing plate which, rather than having a continuous individual channel—as shown in FIG. 1.b—has a distribution between multiple parallel channels;

FIG. 2 shows the schematic setup of a piston clamp unit in which there is disposed a piston clamp in the form of a screw-in piston clamp, where the piston clamp unit has a conduit for fluid supply;

FIG. 3.a shows a schematic diagram of the apparatus of the invention equipped with four reaction cells in plate form, where the reaction cells in plate form are each fixed between receiving units and pistons of the piston clamp units, where the piston clamp units are configured as a common element;

FIG. 3.b shows a schematic diagram of a force distributor element which is configured as a ball element and which is fixed to the tip of a piston;

FIG. 4 shows a schematic diagram of a reactor cell in plate form which is in contact with two piston clamp elements that form a piston clamp unit, where the pistons have cylindrical bars that extend the separation;

FIG. 5 shows a schematic diagram of an apparatus of the invention equipped with three reactor cells in plate form, where the three piston clamp units are arranged in a common element in which the fluid supply conduits for driving of the individual piston clamps run, where the conduits are equipped with valves and the main conduit has a common pressure regulator valve. The individual reaction cells are provided with inlets and outlets, where the outlets lead to liquid collecting vessels;

FIG. 6 shows a schematic diagram of the apparatus shown in FIG. 5, where the apparatus is disposed in an oven chamber and the individual assemblies, specifically the piston clamp units, in a common element; the reaction cells in plate form and the liquid separators are provided with separate temperature control elements;

FIG. 7 shows a schematic diagram of the apparatus given in FIG. 6, where the pistons of the piston clamp units are equipped with a temperature control device and where fluids are fed in via a common fluid inlet that also has a temperature control device. The streams conducted out of the liquid separators may be sent to an analysis unit;

FIG. 8.a shows a schematic diagram of the apparatus equipped with reaction cells in plate form, where the reaction cells in plate form take the form of an individual reaction cell and of a stack of reaction cells. The apparatus shown can accommodate a total of three different groups with reaction cells in plate form;

FIG. 8.b shows a schematic diagram, where the piston clamp units and the receiving units take the form of separate elements, where a holding frame is present for each pair of piston clamp unit and receiving unit;

FIG. 8.c shows a schematic diagram of piston clamp units connected by fluid conduits to a fluid supply tank provided with a pressure regulator;

FIG. 8.d shows a schematic diagram of the piston clamp units with a fluid supply tank which is shown in FIG. 8.c, where the piston clamp units are connected to a holding frame and receiving units, and reaction cells in plate form are disposed between the piston and the receiving units;

FIG. 9 shows a schematic diagram of a reaction cell in plate form which is fixed in a compression unit, where the piston 25 is pressed against the outer surface of the reaction cell and where the piston is simultaneously connected to a sensor element 81 that detects the piston movements; the reaction cell has radiation-transparent windows 83 through which radiation 85 is directed into the interior of the cell;

FIG. 10.a shows a schematic diagram of four reaction cells in a parallel arrangement;

FIG. 10.b shows a schematic diagram of four reaction cells in a series arrangement;

FIG. 11 shows a schematic diagram of two stacks each with three reaction cells in plate form, having a series linkage 93 in the stack on the left-hand side and a parallel arrangement 91 in the stack on the right-hand side;

FIG. 12 shows a schematic diagram of an apparatus formed from a group of four modules, where the modules are connected to a central control unit;

FIG. 13 shows a schematic diagram of an embodiment of an apparatus composed of multiple modules comprising the apparatus of the invention as a module in the form of a plurality of combined modules;

FIG. 14 shows a schematic diagram of a module for supply with liquids and gases;

FIG. 15 shows a schematic diagram of a module with online analysis units;

FIG. 16 shows a schematic diagram of an apparatus of the invention for performance of chemical processes in reaction cells in plate form in a working process for testing of production parts that are functional elements in mass-produced products.

Further features and advantages of the methods of the invention and of the apparatus are apparent from the figures and from the accompanying description of figures. It will be apparent that the features which have been mentioned above and those which are still to be elucidated below can be used not only in the combination specified in each case but also in other combinations or on their own without leaving the scope of the present invention. Working examples of the invention are shown in the figures and are described in detail hereinafter.

### DETAILED DESCRIPTION OF ILLUSTRATIVE EMBODIMENTS

First of all, with reference to the entirety of the figures, a general description of the invention is made, and then the details of the invention are described with a specific reference to the figures.

### Example of the Production Of Catalyst Layers

An example of the use of the apparatus of the invention in conjunction with the development of new and improved catalyst layers that can be screened within a short time by means of the apparatus. The catalyst layers can be produced using any methods known in the field of catalyst synthesis. These are methods of applying catalysts to base plates or else to electrodes or to base plates comprising the electrodes. The production method may comprise at least one method selected from the group of: chemical dip bath, spin coating, dip coating, knife coating, blade coating, injection molding, spray coating, screenprinting, inkjet printing, aerosol jetting, bar application, 3D printing methods, plasma coating.

In the production method, it is possible to use specific sheets in plate form that are selected from the group of porous ceramic layer, porous metal layer, composite material of ceramic and metal. The ceramic materials may be alumina, steatite.

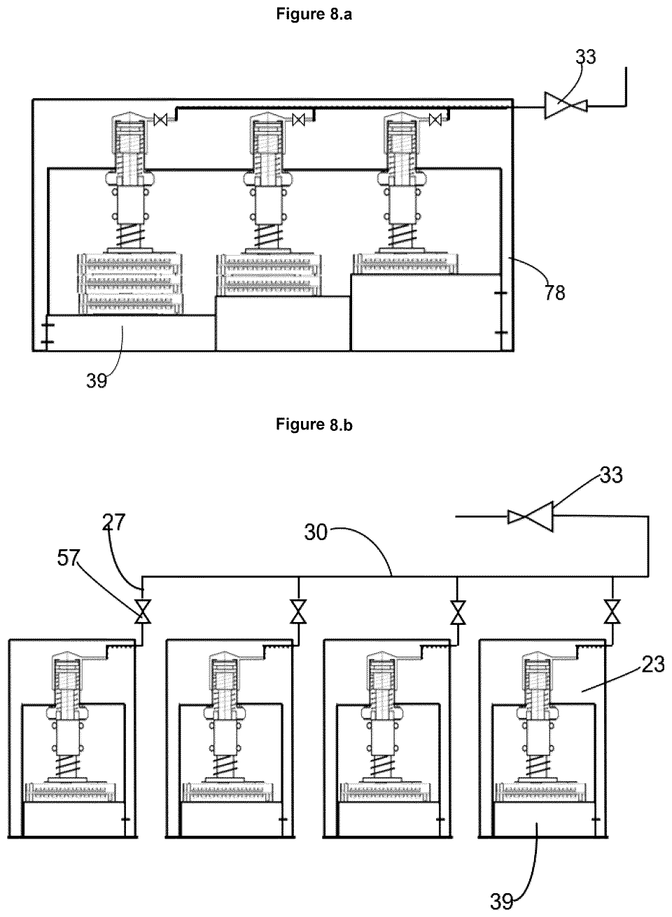

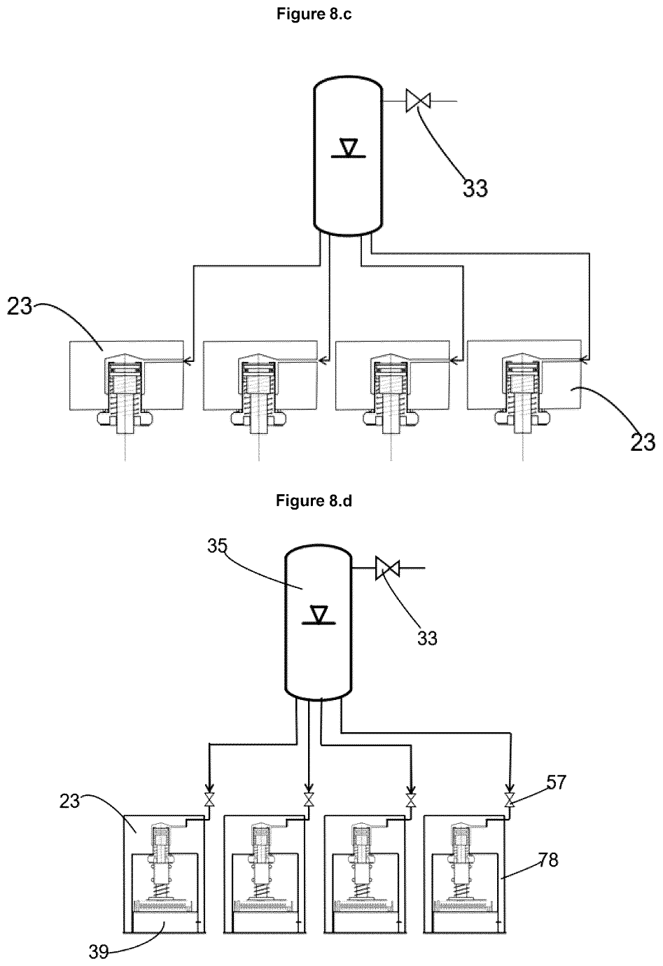

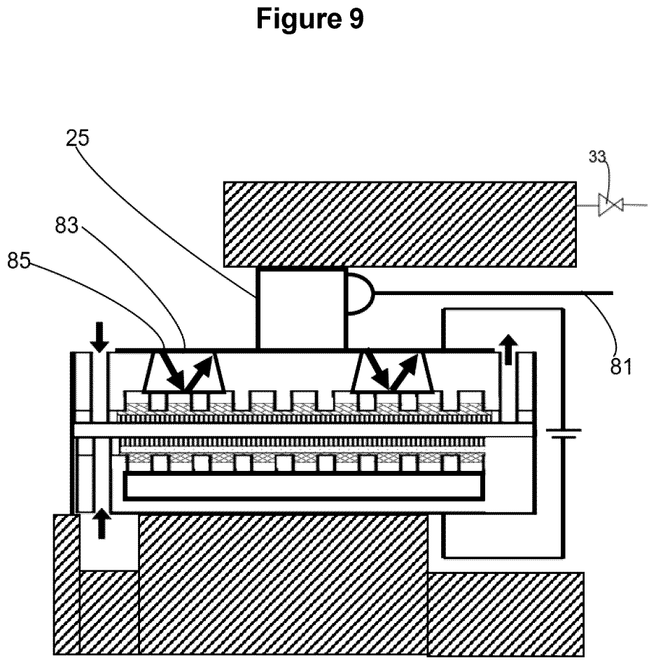

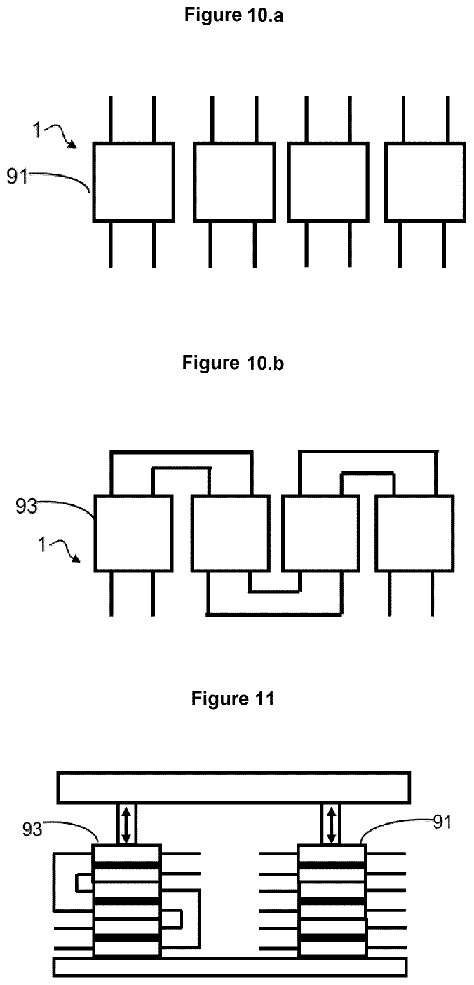

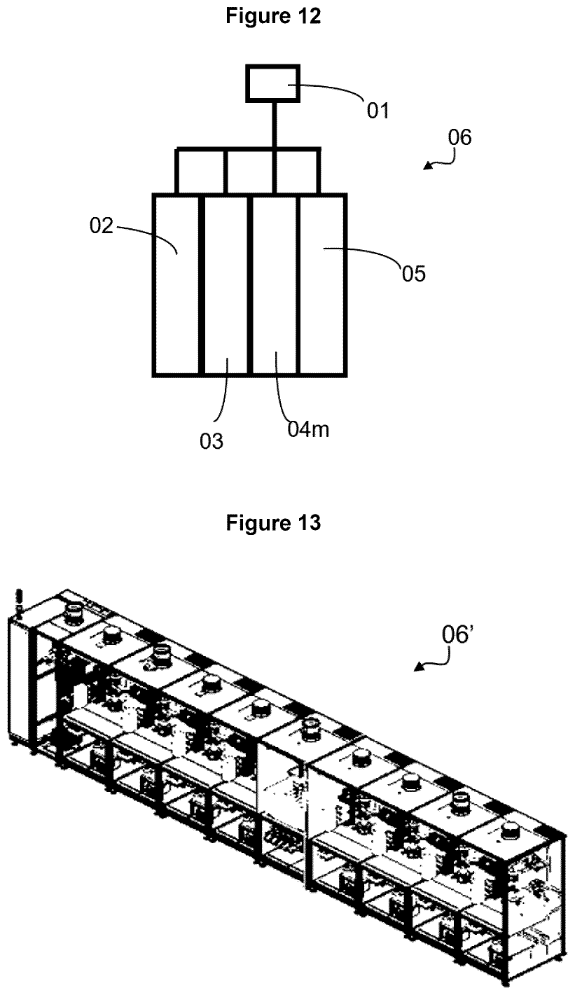

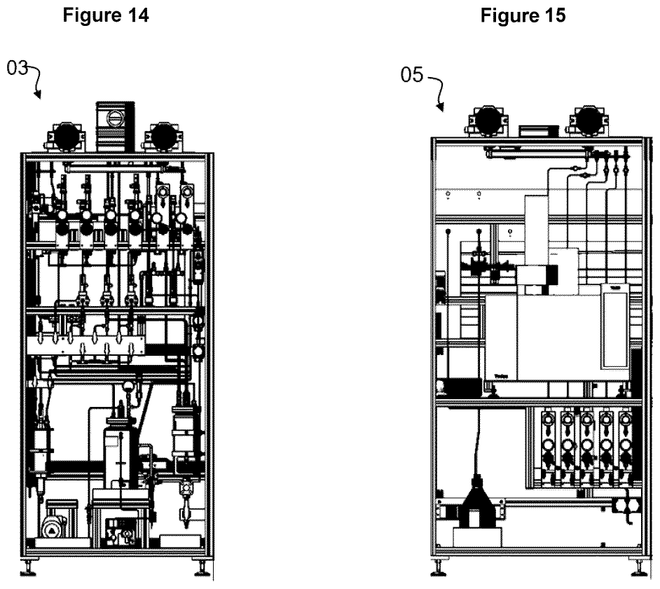

In a preferred embodiment, the apparatus of the invention has a setup corresponding to the diagrams shown in FIG. 5 and FIG. 8. In the diagram shown in FIG. 5, the outer plate surface is in each case pressed in the direction of the stop by two piston clamps (26), whereas, in FIG. 8, the outer plate surface is pressed against the stop only by one piston clamp (26). In both embodiments, a distributor element (23) is apparent, in which there is a common fluid conduit (30) with fluid conduits (27) to the individual piston clamps (26). Switching valves (57) are respectively disposed in the fluid conduits (27), where the actuation of the switching valves (57) breaks the connection of the fluid conduit to the fluid supply (50). It is thus possible by means of the pressure regulator valve (33) and the pressure rule connected to the pressure regulator valve, depending on the valve state of the switching valve, either to determine the pressure values as integral pressure values or as a pressure value based on a selected reaction cell. If the switching valves (57) in the individual conduits are closed apart from an individual switching valve, the pressure value on the pressure regulator relates to that piston clamp unit where the switching valve is open. Selective interrogation, sampling or multiplexing of individual measurements is thus possible.

The apparatus of the invention offers very high flexibility in relation to the chemical processes to be examined. By means of the apparatus, controlled study of a multitude of process parameters is possible, which are collected in the central database in the form of relational process data.

The data registered in the database give process information that can be used for trial planning of future experimental configurations. The program controller or database evaluation may be provided with a program which is independently capable of selecting, on the basis of the analysis of data sets, those process conditions that are particularly favorable. The great flexibility in combination with the detection of large amounts of data makes it possible to accelerate the performance of chemical processes. At the same time, data quality can also be improved in the process data generated since it is also possible because of a parallel arrangement of reaction cells in plate form to conduct the chemical processes in the presence of reference cells that are equipped with reference materials and are conducted under selected reference conditions.

One aspect of the apparatus of the invention and the device of the invention thus relates to the generation of chemical process data having high and improved data quality compared to conventional devices constructed without parallel arrangements. The high quality of data has the advantage that the development of chemical processes can be accelerated since it is possible to reduce the extent of upscaling studies. In this way, it is possible to conserve resources. At the same time, it is possible to develop those chemical processes that can be used for solutions in smaller areas.

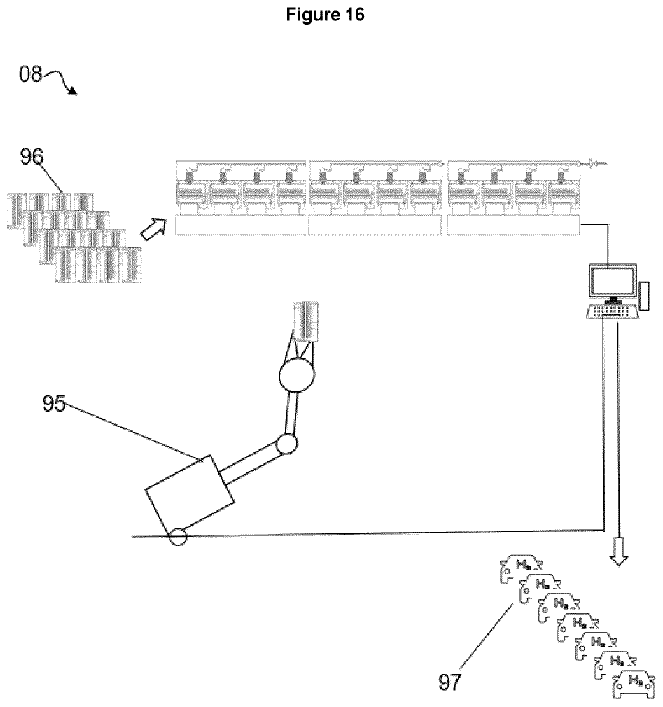

A further aspect of the invention relates to the use of the apparatus of the invention to study chemical processes in reaction cells in plate form in an arrangement for assistance of series production processes in the field of the energy and automotive sector. The invention is especially suitable for use in the field of quality control in series production and also in the performance and testing of conditioning operations. The schematic diagram in FIG. 16 shows the combination of the apparatus of the invention with a robot, such that the operation of the apparatus can be implemented in an at least partly automatic manner; further preferably, the operation of the apparatus is conducted in a fully automatic manner. Use in the field of quality control and in conditioning is particularly advantageous since the piston clamp units are actuatable individually, the reaction cells can be exchanged in a simple manner and a high throughput is possible, such that, with the aid of the apparatus of the invention, in accordance with the production capacities of individual factories, it is possible to conduct production tests (quality control or conditioning or a combination of quality control and conditioning) where the test capacities are in the range of 10-1500 reaction cells per day, preferably in the range of 50 to 1000. The advantages of the invention provide synergistic effects here that also result from the following properties: the test protocols can be chosen such that increased speed can be achieved in the aging of the functional materials and hence in the testing, the performance of the tests can be monitored with sensor elements and the test data registered are stored in a database; the fixing of the reaction cells in the apparatus by means of the piston clamp elements is time-saving and can also be automated.

In a preferred embodiment, the output conduits of the reaction cells in plate form are equipped with a pressure regulator system, where the pressure regulator system is selected from the group of pressure regulator valve disposed directly in the output conduit, or sidestream pressure regulator device which is implemented in conjunction with a pressure regulator by the feeding-in of dilution gases via capillary conduits. In a further-preferred embodiment, the regulation of pressure by conduction of a sidestream is equipped with an adjustable valve that permits fine regulation of the gas stream, preferably a Reco control valve.

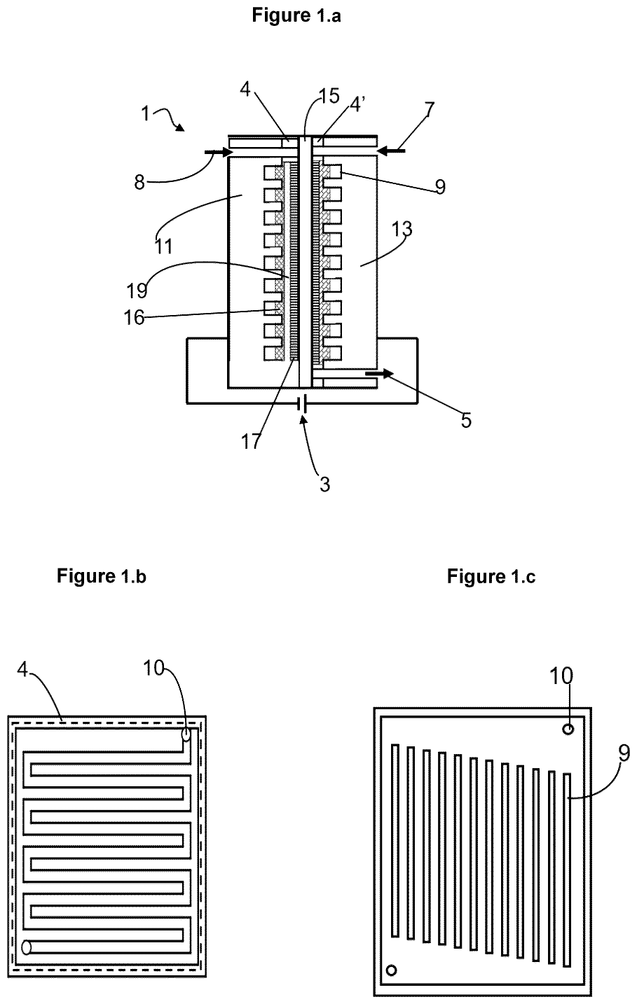

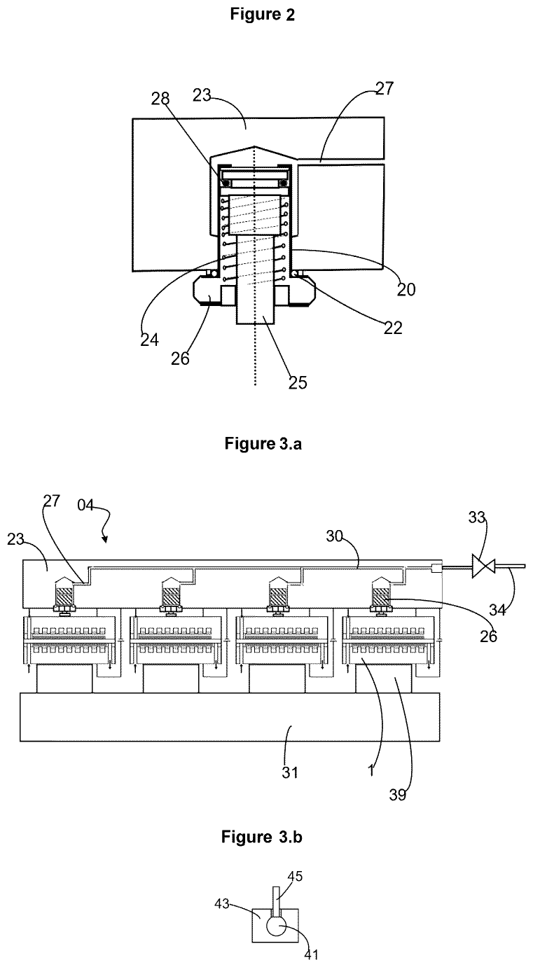

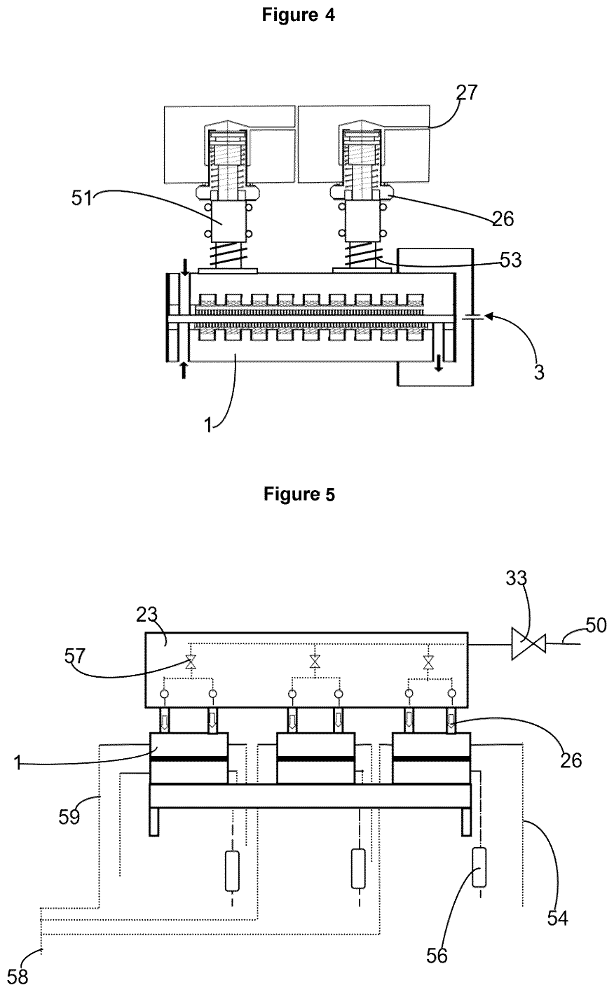

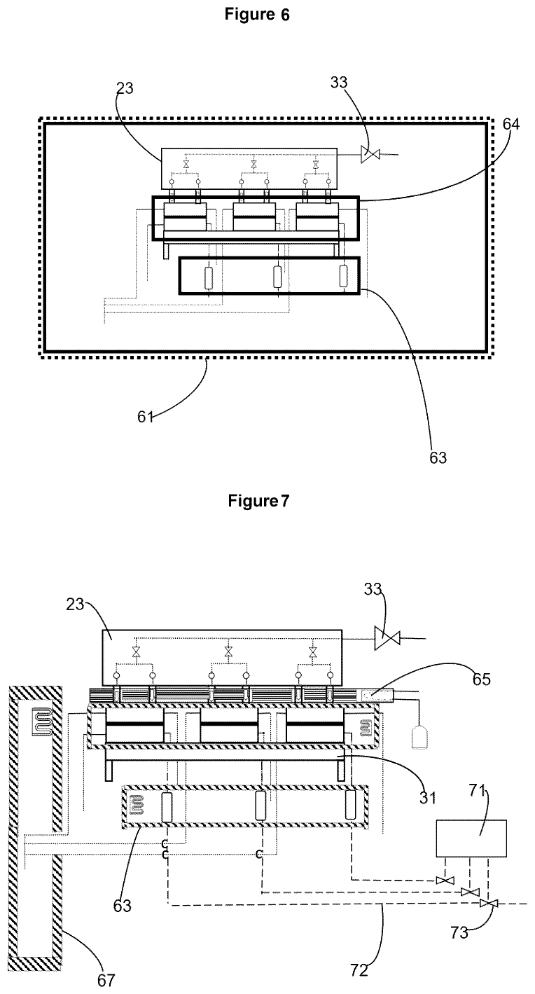

In relation to FIG. 1.b and FIG. 1.c, for configuration of the channels 9, it can be stated that the dimensions of the channels depend on the dimensions of the reaction cell in plate form. In one embodiment, the channels 9 may have the dimensions of parallel channels, where the length of a fluid channel is in the range from 10 to 50 mm and the diameter of a fluid channel in the range from 50 to 2000 μm, further preferably in the range from 100 to 1000 μm, even further preferably within a range from 100 to 500 μm.

The selection of the material for the seals depends on the process parameters, such as the type and concentration of the medium, temperature, pressure. The thickness and shape of the seals depend on the components used. The thickness of the seals may be in the range of 1-2 mm, where the seals may also have a thickness of 3 mm; it is also possible to use seals having thicknesses of <1 mm. The thickness of the sealing elements 4, 4′ used, in FIG. 1.a, depends on the good area of the surfaces of the flanges against which the seals are pressed. The flanges are, for example, the edge regions on the inside of the interiors of the housings of the reaction cells that are pressed, for example, against a different housing part or a functional element. This is shown schematically for the progression of the seal 4 in FIG. 1.b. Functional elements such as the membrane 15 in FIG. 1.a may be surrounded by a frame structure, where the frame structure forms an edge disposed between the halves of the housing, where the frame structure is disposed between the halves of the housing of the plate reactor.

### LIST OF REFERENCE NUMERALS

01 control device
02 control cabinet, electrical supply for regulators
03 supply module, gases and liquids
04 apparatus with reaction cells in plate form in pressing device
04m module comprising an apparatus 04
05 analysis module
06 apparatus formed from a group of four modules 02, 03, 04m and 05, and control device 01
06′ apparatus formed from group of modules with multiple modules 04m and further modules
08 system for performance of quality control on reaction cells or functional elements comprising an apparatus 06 or 06′
1 reaction cell in plate form
3 electrical supply unit
4, 4′ sealing elements
5 outlet
7 inlet
8 inlet
9 channel in housing element
10 inlet, outlet
11 housing element
13 housing element
15 dividing wall, membrane
16 diffusion layer
17 porous catalyst layer
19 electrode
20 thread
22 sealing element
23 piston clamp unit
24 spring
25 piston of the piston clamp
26 piston clamp
27 fluid conduit
28 seal
30 common fluid conduit
31 connecting element for receiving units, or receiving units
33 valve, pressure regulator valve
34 supply conduit
35 fluid supply tank
39 receiving unit(s) for reaction cell(s) in plate form
41 ball element
43 receiver for ball element
45 connecting piece to piston
50 supply conduit
51 spacer in the form of cylindrical bar
53 spring element on the piston
54 output conduit
56 liquid separator
57 switching valve
58 common supply conduit for feed
59 connecting conduit to inlet of a reaction cell
60 housing for temperature control
63 temperature control device for separator
64 temperature control device for reaction cells in plate form
65 cooling device for temperature control of the piston clamps
67 temperature control device for supply unit
71 analysis unit
72 liquid outlet conduit from the separator
73 switching valve with connection to analysis unit
78 holding frame
81 sensor for monitoring of the piston
83 radiation-transparent window in the housing of a reaction cell
85 passage of radiation through transparent window in the housing
91 parallel arrangement of multiple reaction cells
93 series arrangement of multiple reaction cells
95 robot
96 functional elements in test cells
97 reaction cells in mass-produced products

1. An apparatus for studying chemical processes in reaction cells in plate form, having:
a group of reaction cells in plate form or a group of stacks comprising reaction cells in plate form or else comprising individual reaction cells in plate form, and a closure system that enables independent fixing of the individual reaction cells in plate form and stacked reaction cells in plate form,
wherein the closure system comprises receiving units and a plurality of piston clamp units, wherein the piston clamp units have a common drive system,
each reaction cell in plate form or each stack comprising reaction cells in plate form has two outer plate surfaces, where one outer plate surface in each case is in contact with a receiving unit and the other outer plate surface with one or more piston clamps of each piston clamp unit, wherein the piston clamp unit is designed to independently subject the reaction cells in plate form or stacked reaction cells in plate form to a compression force, where the compression force acts at right angles to the plate surface in the direction of the receiving unit,
wherein the reaction cells in plate form or stacked reaction cells in plate form each comprise a plurality of functional elements in plate form, where the functional elements in plate form are catalyst layers, gas diffusion layers, bipolar plates, proton exchange membranes, wherein each reaction cell in plate form has at least one inlet for a reactant and at least one outlet for a product, and wherein the stacked reaction cells in plate form each have at least one inlet for a reactant and at least one outlet for a product.

2. The apparatus for studying chemical processes according to claim 1, wherein the reaction cells in plate form or stacked reaction cells in plate form each comprise a plurality of functional elements in plate form, each selected from the group consisting of a catalyst layer, a gas diffusion layer, a bipolar plate, a proton exchange membrane, an anion exchange membrane, and a separation membrane.

3. The apparatus for studying chemical processes according to claim 1, wherein the piston clamp units have a fluidic drive system, wherein the piston clamp units are connected by conduits to a common fluid supply conduit or to a common fluid supply tank, wherein the common fluid supply conduit or the fluid supply tank is connected to a pressure regulator valve, wherein there are switching valves in the conduits to the common fluid supply conduit or the common fluid supply tank, wherein the fluid stream through the fluid conduit can be switched on and off by means of actuation of the switching valves.

4. The apparatus for studying chemical processes according to claim 1, wherein, with respect to the piston clamp unit of the closure system, the closure system has one piston clamp per reaction cell in plate form or one piston clamp per stacked reaction cell in plate form.

5. The apparatus for studying chemical processes according to claim 1, wherein the reaction cells in plate form have separation membranes and electrodes and are divided into half-cells, wherein the electrodes are connected to electrical supply wires, wherein the reaction cells in plate form are configured as electrolysis cells or galvanic cells.

6. The apparatus for studying chemical processes according to claim 1, wherein there is a force distributor element at the tip of each piston of the piston clamps, wherein the piston or the force distributor element is equipped with a sensor that can measure a geometric change in the reaction cell during the reaction, each sensor being a force measurement sensor or measurement sensor selected from the group consisting of an expansion measurement strip, a distance detector, and an interference measurement analyzer.

7. The apparatus for studying chemical processes according to claim 1, wherein one or more of the reaction cells in plate form have one or more sensors connected to sites in the interior of the reaction cells, wherein the sensors are sensors for the performance of at least one in situ test method selected from the group consisting of electrochemical dilatometry for characterization of the change in thickness of electrodes and light-microscopy or spectroscopy characterization via glass fibers relating to electrodes or membranes.

8. The apparatus for studying chemical processes according to claim 1, wherein the receiving units take the form of physically separate units or of a physically connected unit; if the receiving units take the form of physically separate units, each receiving unit has a dedicated holding frame connected to one piston clamp unit; if the receiving units take the form of a physically connected unit, the receiving elements have a common holding frame.

9. The apparatus for studying chemical processes according to claim 1, wherein the reaction cells in plate form have an inner plate area in the range from 1.5×1.5 cm² to 30×30 cm².

10. The apparatus for studying chemical processes according to claim 1, wherein the pistons of the piston clamps are equipped with spacer elements.

11. The apparatus for studying chemical processes according to claim 1, wherein the receiving units carrier elements are in the form of grooves, depressions or compartments in which the reaction cell in plate form or stacked reaction cells in plate form are positioned.

12. The apparatus for studying chemical processes according to claim 1, wherein the group of reaction cells in plate form or group of stacked reaction cells in plate form or group of plate reactors comprising one or more plate reactor stacks is surrounded by a temperature control device.

13. A method of studying chemical processes in reaction cells in plate form by means of an apparatus according to claim 1, wherein the method comprises:
positioning a plurality of reaction cells in plate form or stacks comprising reaction cells in plate form with the outer face of the plate on the top side of a receiving unit;
compressing the reaction cells in plate form or the stack comprising reaction cells in plate form by means of piston clamps, where one or more piston clamps per reaction cell in plate form exert a compression force on the outer plate surface of the individual reaction cells that acts at right angles to the plate surface in the direction of the stop and hence closes off the interior of the individual reaction cells in a sealing manner;
establishing the connections of the fluid conduits to the supply conduits and outlets, optionally establishing the connections to the electrical supply wires for the electrodes;
operating the reaction cells in plate form or the stack comprising reaction cells in plate form under the chemical process conditions, where the reaction cells in plate form in the individual stacks may be connected in series or in parallel.

14. The method of studying chemical processes according to claim 13, wherein, during the operation of the reaction cells under the chemical process conditions, one or more process parameters per reaction cell are registered.

15. The method of studying chemical processes according to claim 14, wherein a comparison of registered process parameters per reaction cell with target parameters is conducted; the target parameters may be given by reference data or by process parameters that are registered in adjacent reaction cells;
exchange of individual reaction cells in plate form by selective release of piston clamps and supply conduits.

16. The method of studying chemical processes according to claim 13, wherein the method is conducted in combination with an online analysis of product fluid streams.

17. A program controller for control of an apparatus according to claim 1, wherein the program controller comprises a database in which the measurements are stored.

18. A program controller for control of a method of studying chemical processes according to claim 13, wherein the program controller comprises a database in which the measurements are stored.
